(19) United States
(12) Patent Application Publication
(10) Pub. No.: US 2013/0181940 A1
(43) Pub. Date: Jul. 18, 2013

(54) Capacitive Touch Display Device

(71) Applicant: NOVATEK Microelectronics Corp., Hsin-Chu (TW)

(72) Inventors: Chih-Chang Lai, Taichung City (TW); Jyun-Sian Li, Tainan City (TW)

(73) Assignee: NOVATEK MICROELECTRONICS CORP., Hsin-Chu (TW)

(21) Appl. No.: 13/674,107

(22) Filed: Nov. 12, 2012

(30) Foreign Application Priority Data
Jan. 13, 2012 (TW) 101101351

(51) Int. Cl. G06F 3/044

(52) U.S. Cl. CPC G06F 3/044
USPC 345/174

(57) ABSTRACT

A capacitive touch display device is disclosed. The capacitive touch display device includes a display, a covering glass layer, and a sensing device including a driving signal layer disposed on the display, the driving signal layer including a plurality of driving electrodes, for outputting a plurality of driving signals, and a receiving signal layer disposed between the covering glass layer and the driving signal layer, the receiving signal layer including a plurality of receiving electrodes, for inducing the plurality of driving signals and outputting a plurality of touch sensing signals accordingly, wherein the plurality of receiving electrodes includes at least one hole for enhancing signal inducement.

### BACKGROUND OF THE INVENTION

1. Field of the Invention

The present invention relates to a capacitive touch display device, and more particularly, to a capacitive touch display device having holes in the receiving electrodes to enhance signal inducement.

2. Description of the Prior Art

A touch display device provides intuitional and easy operations and has been widely utilized among electrical products. A capacitive touch display device has many advantages such as multi-touch points, high detection accuracy, high spatial resolution and durableness. For these reasons, the capacitive touch control is the most popular technique used today.

The touch control display device includes a display panel and a transparent touch panel. Through attachment of the display panel to the transparent touch panel, the touch control display device can realize functions of touch control as well as display. Capacitive touch control techniques detect capacitance changes caused by human beings or objects touching the touch panel, so as to determine a touch event. Please refer to FIG. 1A and FIG. 1B. FIG. 1A is a schematic diagram of a side view of a conventional capacitive touch panel 10 and FIG. 1B is a schematic diagram of a top view of a sensing device 100 of the conventional capacitive touch panel 10. As shown in FIG. 1A, the capacitive touch display device 10 includes the sensing device 100, a display 120 and a covering glass layer 140. The sensing device 100 is interlaced by Indium Tin Oxide (ITO) to form a sensing array at its surface, and is disposed between the display 120 and the covering glass layer 140. When a user (object) touches the capacitive touch display device 10, a coupling capacitor is formed between a surface of the sensing device 100 and the finger of the user. The sensing device 100 may then detect a capacitance variation to determine a touch position touched by the user accordingly.

In detail, as shown in FIG. 1B, the sensing device 100 includes a plurality of first sensing electrodes 14C, a plurality of second sensing electrode 14D and a plurality of bridges 11, wherein each of the sensing electrode 14C and 14D is a two-dimensional rhomboid shape. The first sensing electrodes 14C are interlaced with the second sensing electrodes 14D. The second sensing electrodes 14D next to each other are interconnected along a vertical-axis (X-axis). The first sensing electrodes 14C next to each other are interconnected to other first sensing electrodes 14C along a horizontal-axis (Y-axis) via the bridges 11. The capacitive touch display device 10 realizes touch position determination via inputting driving signals into the sensing electrodes 14C (or 14D) and detecting a capacitance variation of the touch position transmitted from connecting lines from the X-axis and the Y-axis, respectively.

However, the sensing electrodes 14C and 14D are completely exposed to the display 120, such that the sensing electrodes 14C and 14D easily receive noise emitted from the display 120 leading to a weak sensitivity of the capacitive touch display device 10.

There is a double-layer sensing device to isolate the noise from the display. Please refer to FIG. 2A and FIG. 2B. FIG. 2A is a schematic diagram of side view of a capacitive touch display device 20, FIG. 2B is a schematic diagram of top view of a sensing device 200 in FIG. 2A. The touch display device 20 includes a sensing device 200, a display 220 and a covering glass layer 240. The sensing device 200 includes a driving signal layer 201 and a receiving signal layer 202. In such a structure, the driving signal layer 201 isolates the noise from the display 220 to avoid exposing the receiving signal layer 202, i.e. the display 220.

Furthermore, please continue to refer to FIG. 2B. The driving layer 201 includes a plurality of driving electrodes 24D extended along the X direction. The receiving layer 202 includes a plurality of receiving electrodes 24C extended along the Y direction. The sensing device 200 inputs driving signals to the driving electrodes 24D one by one to generate inducing signals on the receiving electrodes 24C accordingly, so as to calculate a touch coordinate of the touch position. However, the sensing device 200 having the double-layer structure in FIG. 2A and FIG. 2B may reduce receiving the noise, but the driving signals usually have a small signal intensity or a small voltage, and thus the induced signals on the receiving electrodes 24C are even weaker, which leads to a bad accuracy of the touch position.

In short, although the traditional double-layer sensing device can reduce noise, signal intensities of the receiving signals induced by the receiving electrodes 24C are still weak. Therefore, how to improve the signal intensities of the induced signals such that the capacitive touch display device may determine the touch position more precisely and easily has become a critical issue in the industry.

### SUMMARY OF THE INVENTION

It is therefore an object of the present invention to provide a capacitive touch display device opening holes on receiving electrodes to enhance signal inducement.

The present invention discloses a capacitive touch display device including a display, a covering glass layer, and a sensing device including a driving signal layer disposed on the display, the driving signal layer including a plurality of driving electrodes for outputting a plurality of driving signals, and a receiving signal layer disposed between the covering glass layer and the driving signal layer, the receiving signal layer including a plurality of receiving electrodes for inducing the plurality of driving signals and outputting a plurality of touch sensing signals accordingly, wherein the plurality of receiving electrodes includes at least one hole for enhancing signal inducement.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of side view of a traditional capacitive touch display device.

FIG. 1B is a top view of the sensing device shown in FIG. LA.

FIG. 2A is a schematic diagram of side view of another traditional capacitive touch display device.

FIG. 2B is a top view of the sensing device shown in FIG. 2A.

FIG. 3 is a schematic diagram of a sensing device for a capacitive touch display device according to an embodiment of the present invention.

FIG. 4A is a schematic diagram of the electric field lines induced on the receiving electrodes when the sensing device shown in FIG. 3 is not touched by the human body.

FIG. 4B is a schematic diagram of the electric field lines induced on the receiving electrodes when the sensing device shown in FIG. 3 is touched by the human body.

FIG. 5 is a voltage-time diagram of the receiving signals when there are holes and when there are no holes on the receiving electrodes of the computing unit shown in FIG. 3.

FIG. 6A to FIG. 6D are schematic diagrams of the holes having different geometric shapes.

FIG. 6D is a schematic diagram of the area of the receiving electrodes overlapping the driving electrodes includes two holes.

FIG. 6E and FIG. 6F are schematic diagrams of the hole having a rectangular shape and a semicircular shape lying in the side edges of the receiving electrodes, respectively.

FIG. 7 is a schematic diagram of the receiving electrodes having a U-shape.

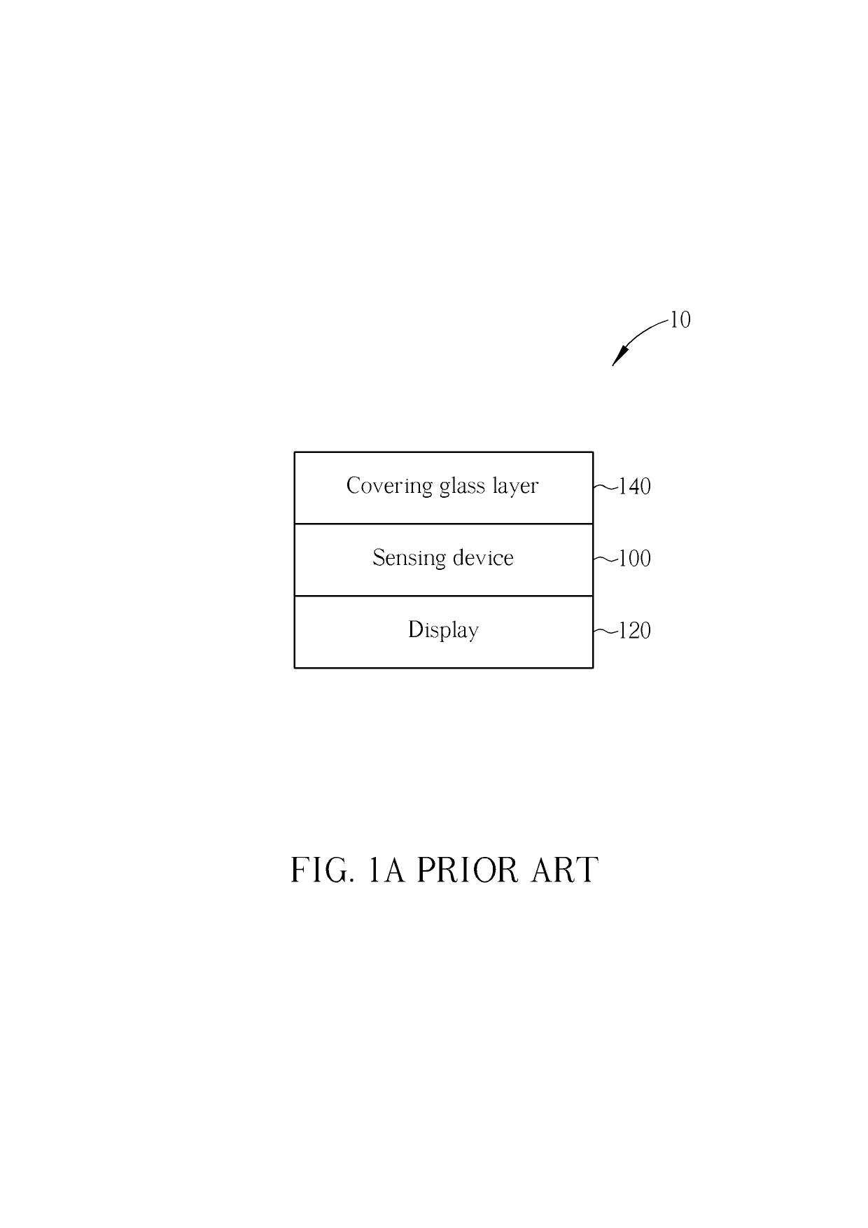

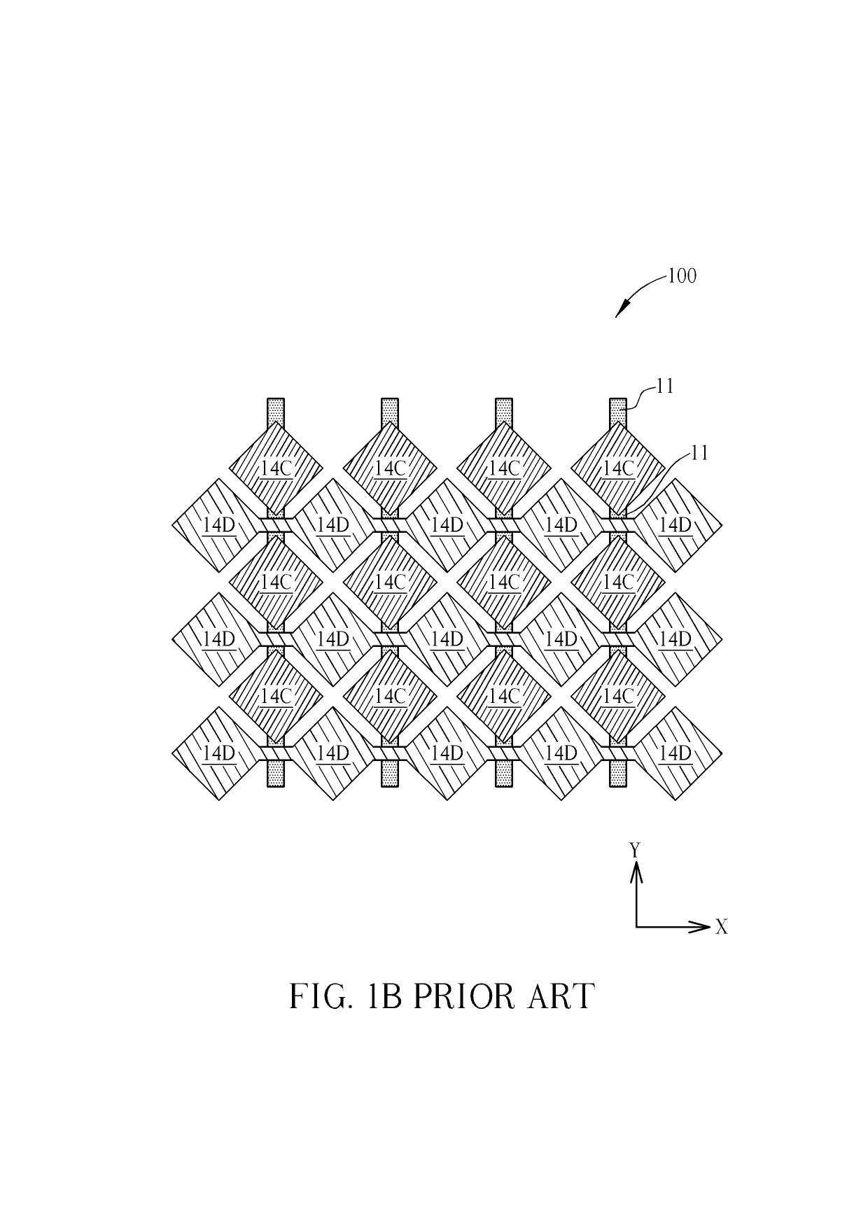

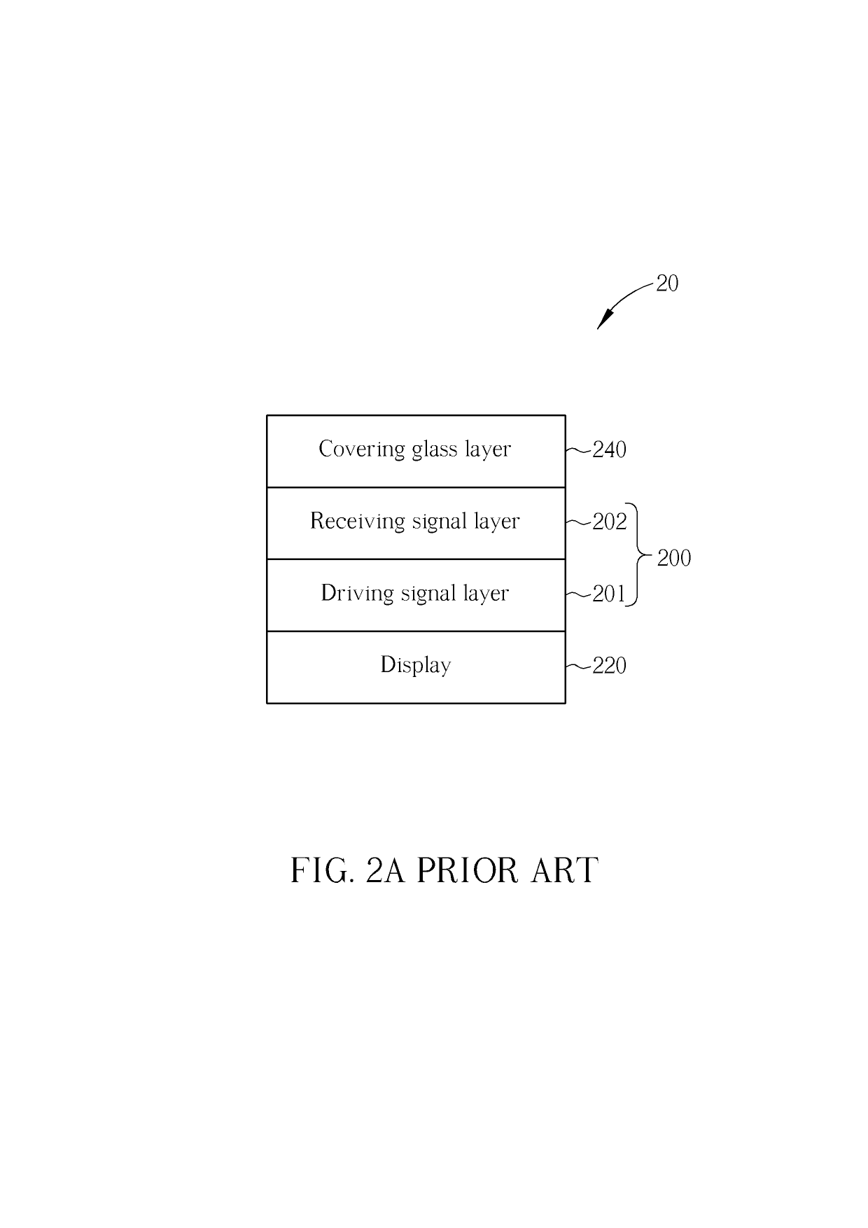

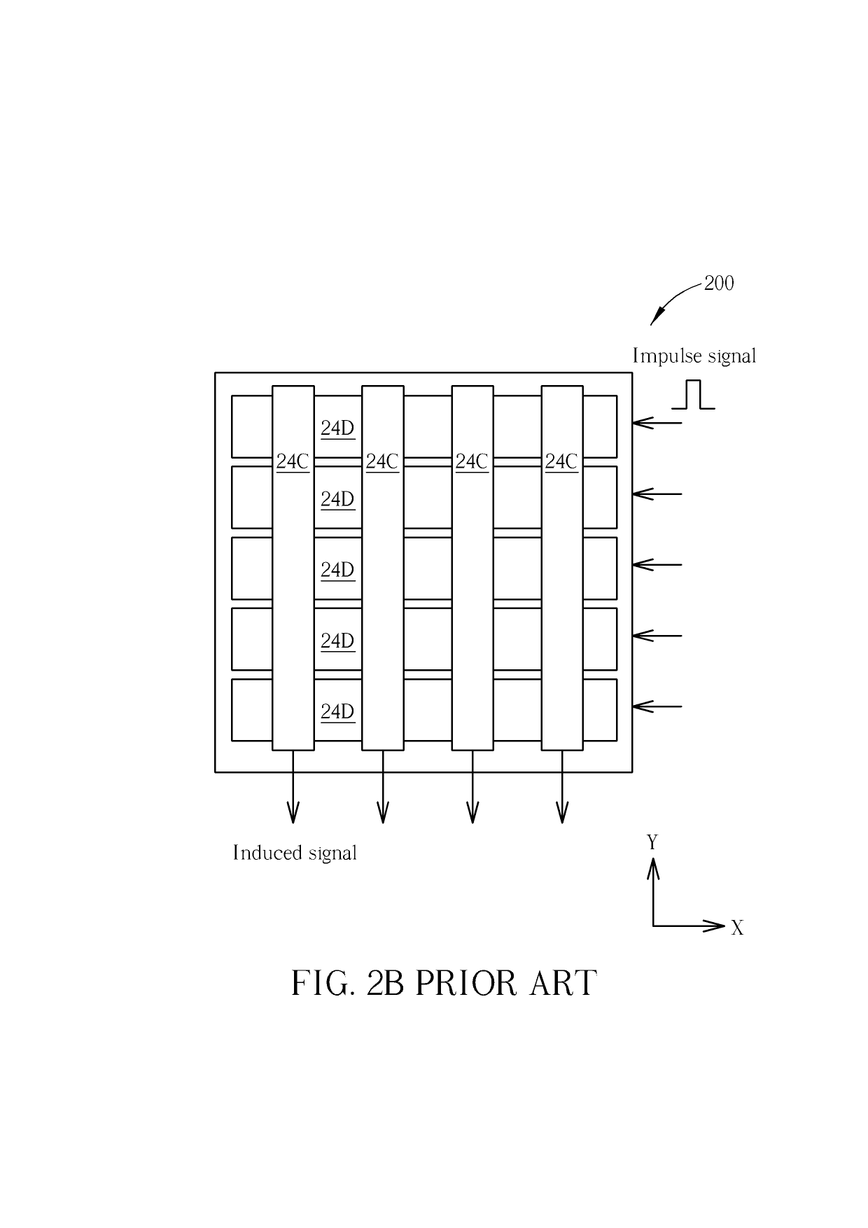

### DETAILED DESCRIPTION

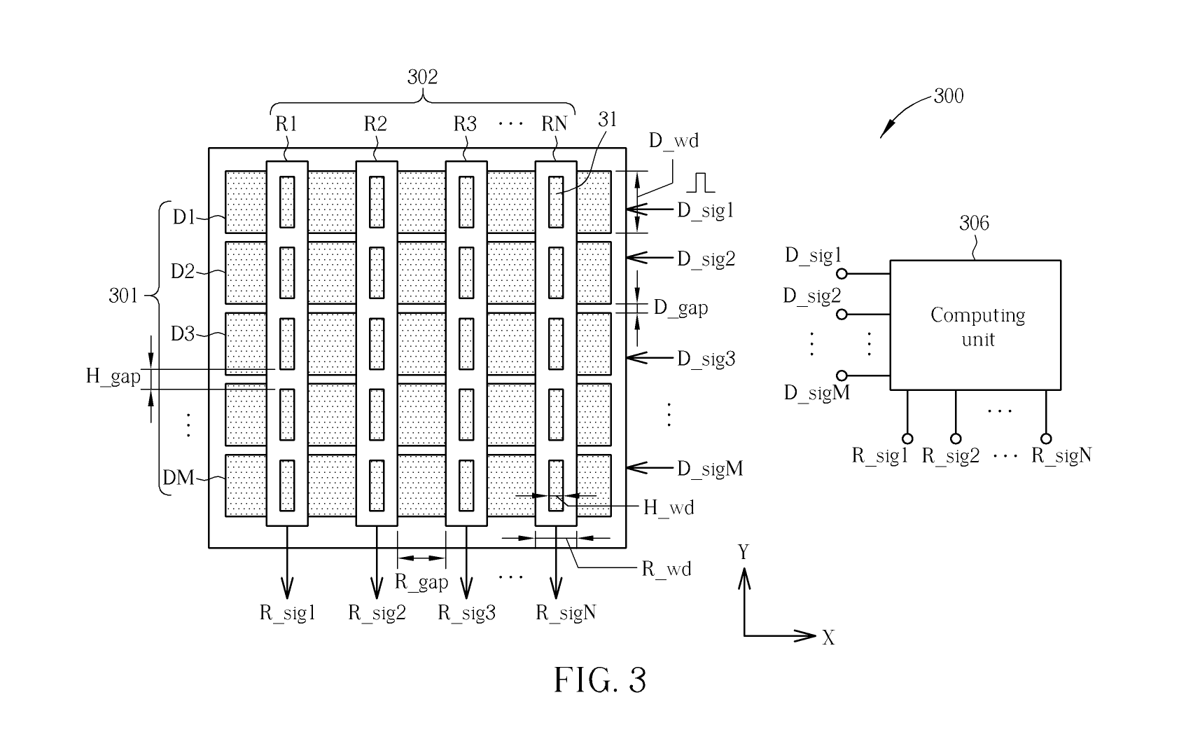

Please refer to FIG. 3, which is a schematic diagram of a sensing device 300 for a capacitive touch display device according to an embodiment of the present invention. A double-layered structure of the sensing device 300 is similar to a structure of the sensing device 200, i.e. the sensing device 300 comprises a driving signal layer 301 and an inducing signal layer 302. The driving signal layer is disposed on a display of the capacitive touch display device. The receiving signal layer is disposed between the driving signal layer 301 and a covering glass layer of the capacitive touch display device to avoid the receiving electrodes completely being exposed to the noise source, i.e. the display. As shown in FIG. 3, the driving signal layer 301 includes driving electrodes D1-DM, the receiving signal layer 302 includes receiving electrodes R1-RN. The driving electrodes D1-DM are used for transmitting driving signals Dsig1-DsigM. The receiving electrodes R1-RN are used for inducing driving signals D_sig1-D sigh to output receiving signals R_sig1-R sigN accordingly.

Noticeably, a difference between the sensing device 300 and the sensing device 200 is that each of the receiving electrodes R1-RN includes at least one hole 31. The input driving signals Dsig1-DsigM are sequentially transmitted one by one via the driving electrodes D1-DM from the computing unit 306. Please note that the receiving electrodes R1-RN of the sensing device 300 include at least one hole 31 for enhancing signal inducement.

Since the driving electrodes D1-DM and the receiving electrodes R1-RN are usually disposed with a trellis structure, the hole 31 is preferably lying in a projection area of the driving electrodes overlapping the receiving electrodes. In other words, the hole 31 may overlap the projection area of the driving electrodes overlapping the receiving electrodes. For example, part of the hole 31 overlaps a projection area of one of the receiving electrodes overlapping one of the driving electrodes, or the hole 31 completely overlaps the projection area of one of the receiving electrodes overlapping one of the driving electrodes. In such a situation, when human body touches the sensing device 300, most electric field lines induced on the receiving electrodes R1-RN are conducted to the human body through the hole 31, such that signal intensities of the receiving signals R_sig1-R_sigN are greatly reduced to effectively improve a Signal-to-Noise Ratio (SNR) of the receiving signals. As a result, the touch position may be detected much more sensitively and precisely.

In short, the capacitive touch display device of the present invention has openings or holes on the receiving electrodes to increase a capacitance variation when the human body touches the capacitive touch display device to improve the SNR of the capacitive touch display device.

Moreover, the sensing device 300 further includes a computing unit 306 coupled to the driving electrodes D1-DM and the receiving electrodes R1-RN. The driving signals D_sig1-D_sigM are sequentially transmitted one by one to the driving electrodes D1-DM. The receiving electrodes R1-RN induce the driving signal D_sig1-D_sigM to output the receiving signals R_sig1-R_sigN to the computing unit 306. In such a situation, the computing unit 306 may generate a touch detecting result according to the driving signals D_sig1-D_sigM and a difference computing result generated by comparing the receiving signals R_sig1-R_sigN before and after the capacitive touch display device 10 is touched by a finger of a user. The computing unit 306 determines whether there is a touch event and a touch position touched by the user accordingly. For example, if the difference computing result is less than a threshold value, the touch detecting result indicates a non-touch event. On the other hand, if the difference computing result is greater than or equal to the threshold value, the touch detecting result indicates a touch event, and the computing unit 306 determines a touch position touched by the user according to the difference computing result, positions of the driving electrodes D1-DM and positions of the receiving electrodes R1-RN. Therefore, the openings or holes 31 on the receiving electrodes of the inducing signal layer 302 may increase the difference computing result of the receiving signals before and after the capacitive touch display device is touched by the user, such that the computing unit 306 may easily determine whether the difference computing result is greater than the threshold value and easily determine the touch position of the touch event.

FIG. 3 further illustrates practical sizes of the sensing device 300. For example, a width D_wd of the driving electrodes along the Y direction is 5 mm; a gap D_gap between two driving electrodes is 100 um; a width R_wd of the receiving electrodes along the X direction is 2.5 mm; a R_gap between two receiving electrodes is 2.5 mm; a width H_wd of the hole 31 along the X direction is 1.5 mm; a gap H_gap between two holes along the Y direction is 1.1 mm. Please note that the sizes in FIG. 3 are reference sizes but not limited to this, those skilled in the art may make proper modifications according to different product categories and production standards.

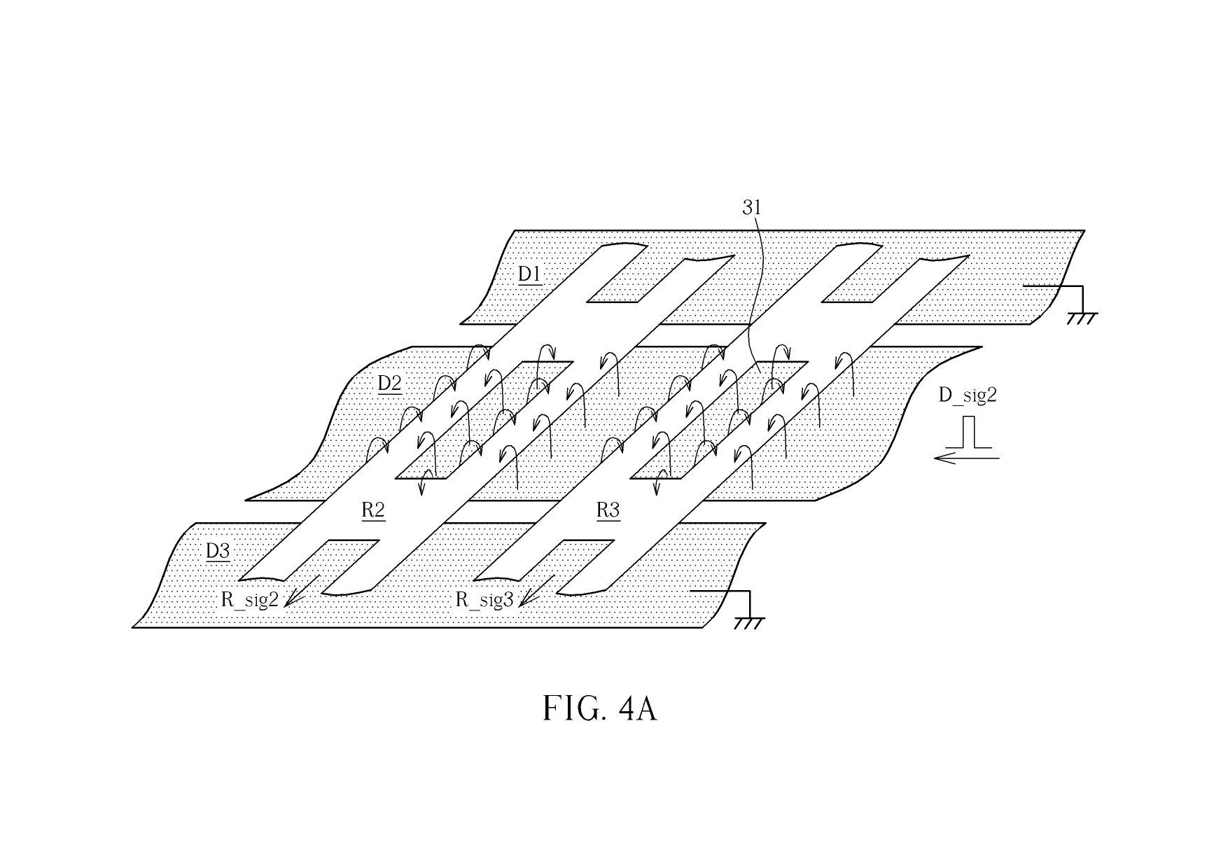

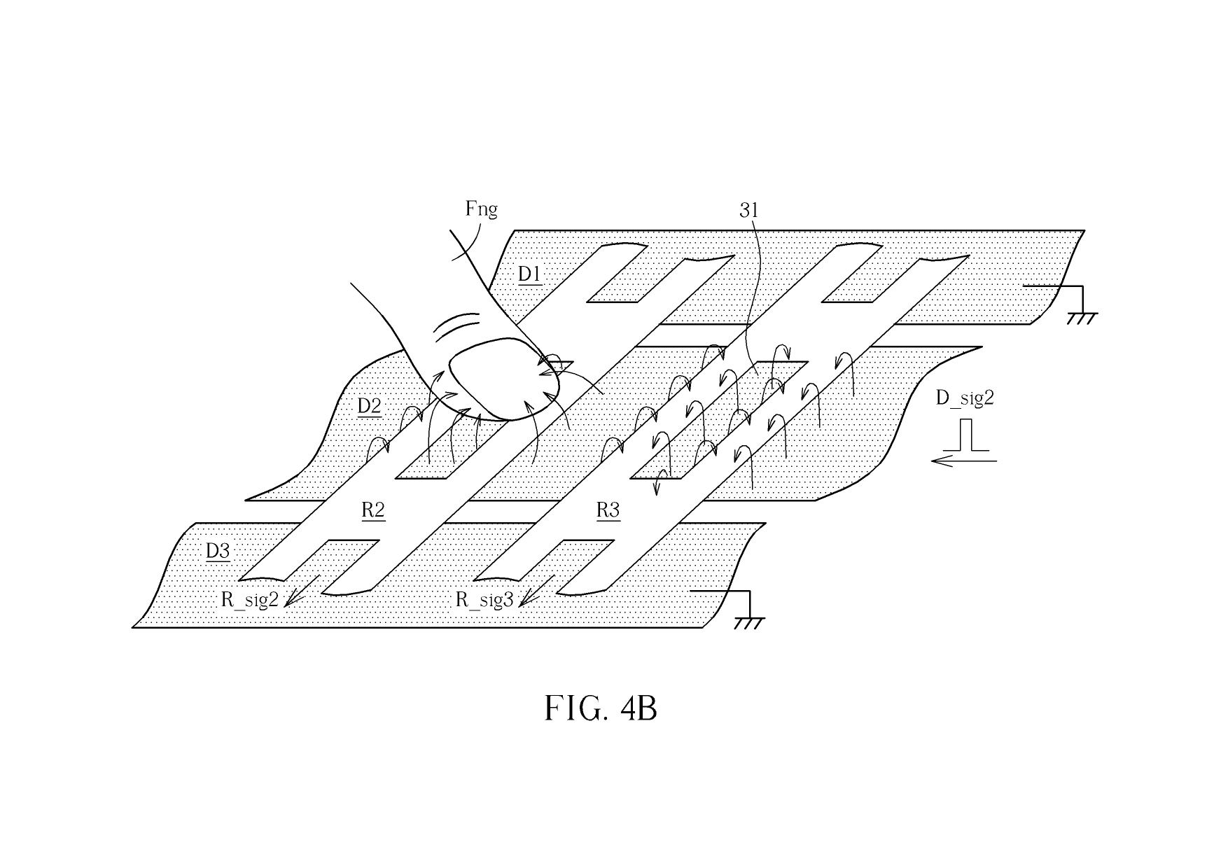

Please refer to FIG. 4A to FIG. 4B for illustrating an operation of the sensing device 300. FIG. 4A is a schematic diagram of the electric field lines induced on the receiving electrodes when the sensing device 300 is not touched by the human body. FIG. 4B is a schematic diagram of the electric field lines induced on the receiving electrodes when the sensing device 300 is touched by the human body. Taking the driving electrodes D1-D3 and the receiving electrodes R2 and R3 for example, assume the driving signal D_sig2 is transmitted by the driving electrode D2, the electric field lines are induced and generated on areas of the driving electrode D2 overlapping the receiving electrodes R2 and R3, i.e. the projection areas of the driving electrode D2 overlapping the receiving electrodes R2 and R3, to generate the receiving signals R_sig2 and R_sig3, respectively. All other driving electrodes D1 and D3-DM are coupled to the ground (or zero voltage), so there is no induced electric field lines generated on the driving electrodes D1 and D3-DM.

Noticeably, there are openings on the receiving electrodes R2 and R3, which induces extra electric field lines formed on an edge of the hole 31, and makes the induced electric field lines generated on edges of the receiving electrodes R2 and R3 more than that of the traditional receiving electrodes.

Please continue to refer to FIG. 4B, which is a schematic diagram of the electric field lines induced on the receiving electrodes when the sensing device 300 is touched by the human body. As shown in FIG. 4B, a finger Fng is a conductor and can conduct the electric field lines from the receiving electrodes R2 to the human body. Since the receiving electrodes R1-RN has the openings, a great amount of the electric field lines is conducted from the receiving electrodes R2 to the finger Fng when the finger Fng touches the receiving electrodes R2, such that a signal intensity of the receiving signal R_sig2 is much less than signal intensities of the receiving signals R_sig1 and R_sig3-R_sigN. Therefore, if the computing unit 306 computes the signal difference value of the receiving signal R_sig2 before and after the sensing device 300 is touched by the finger Fng, and determines the signal difference value is greater than a threshold value, the computing unit 306 may determine the finger Fng touches the display where the driving electrodes D2 overlaps the receiving electrodes R2.

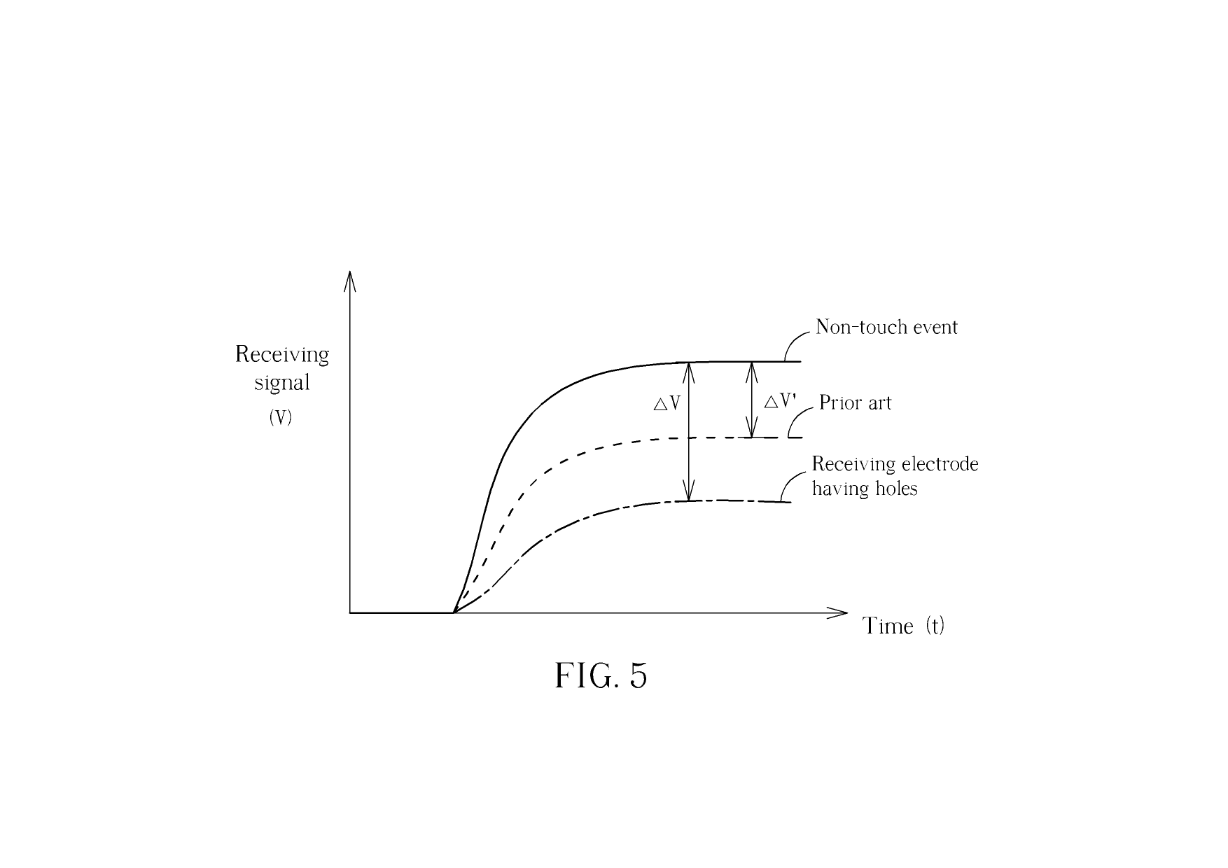

According to the above description, the present invention utilizes the openings or holes on the receiving electrodes R1-RN to increase the electric field lines generated by the driving signal D_sig induced on the receiving electrodes R1-RN, to increase the amount of the electric field lines conducted from the sensing device to the finger Fng, such that the signal difference value is great before and after the sensing device is touched by the finger Fng touch and the SNR of the receiving signal of the computing unit 306 may be improved. Please refer to FIG. 5, which is a voltage-time diagram of the receiving signals when there are holes and there are no holes on the receiving electrodes of the computing unit 306. For the non-touch event, the receiving signal illustrated with a solid line and having the highest signal intensity indicates there is no human body conducting the electric field lines. For the touch-event, the receiving signal illustrated with a dashed line and having the second highest signal intensity is generated by the traditional receiving electrodes; the receiving signal illustrated with a dotted line and having the lowest signal intensity is generated by the receiving electrodes having the holes 31. As can be seen from FIG. 5, a signal difference value ΔV of the present invention is greater than a signal difference value ΔV′ of the prior art, with the same noise level, and an SNR of the receiving signal of the present invention is better than an SNR of the receiving signal of the prior art.

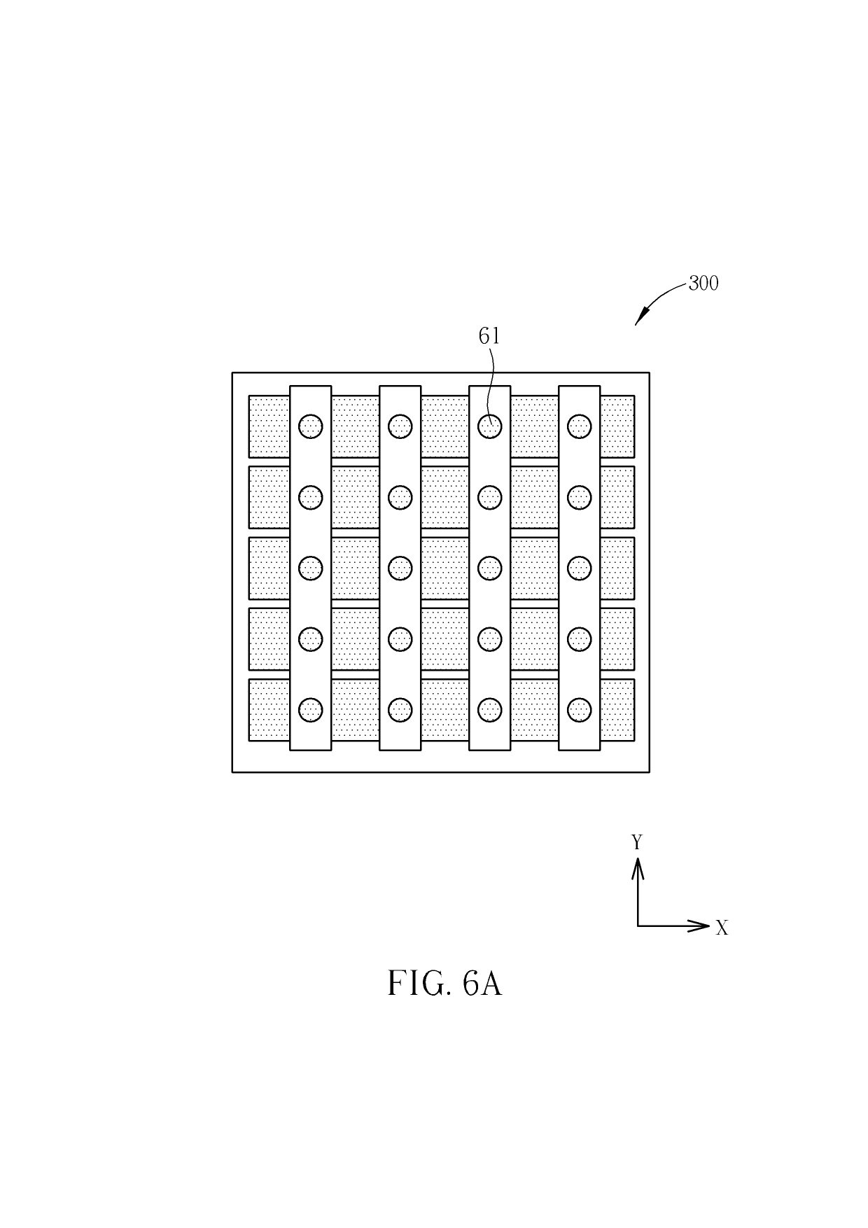

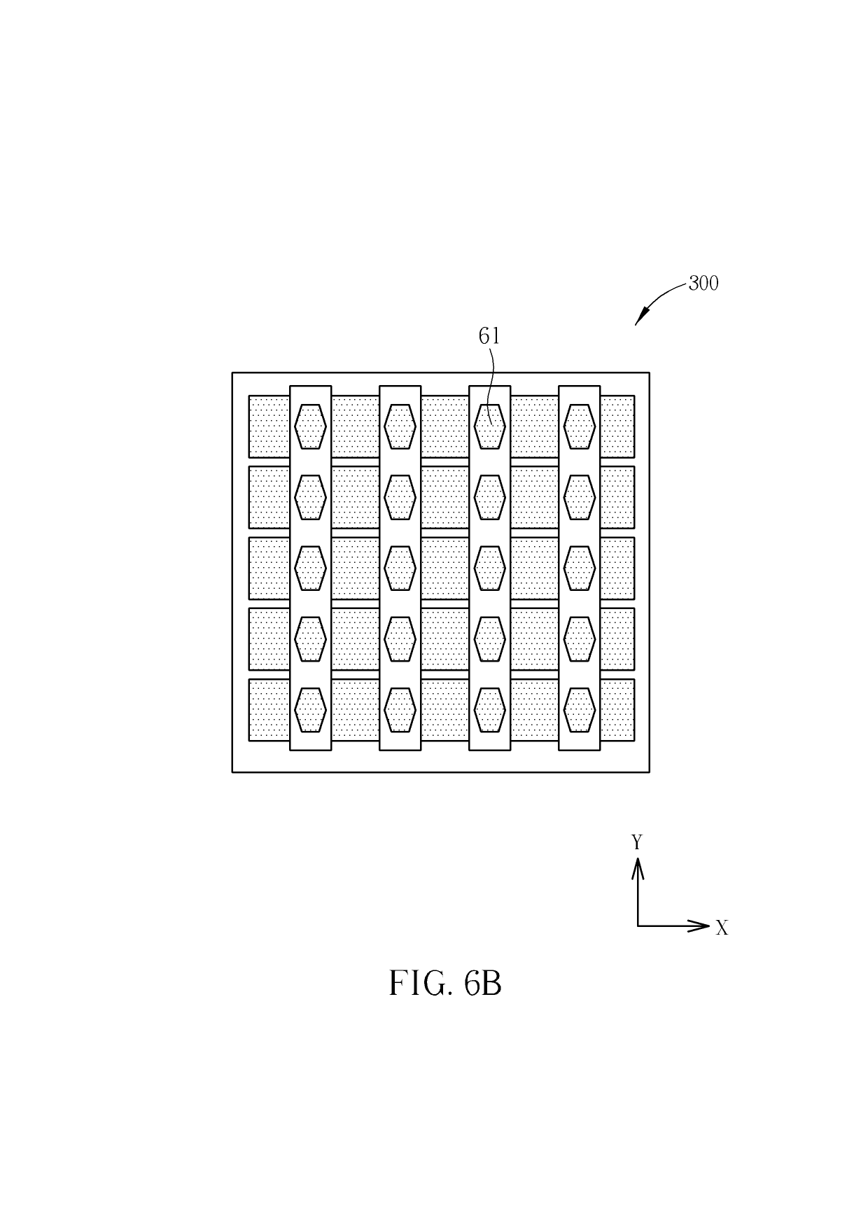

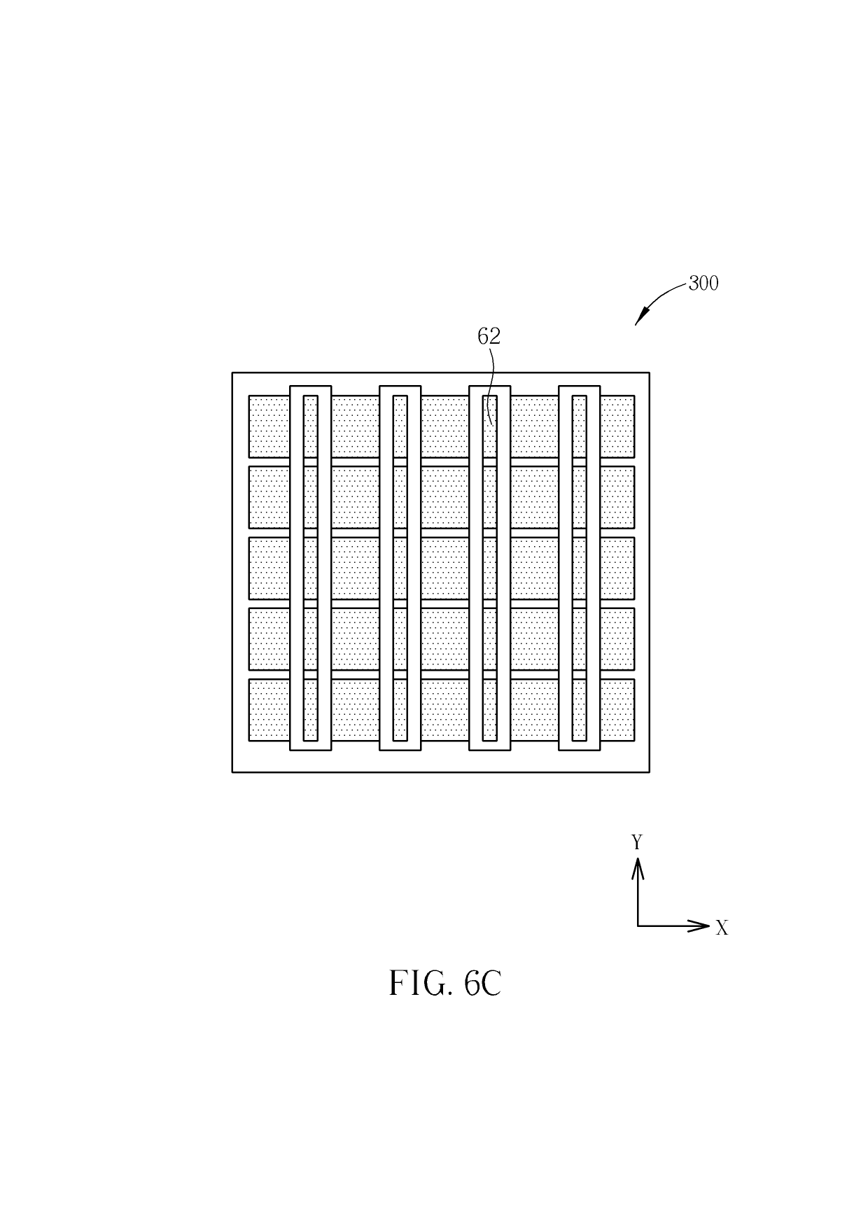

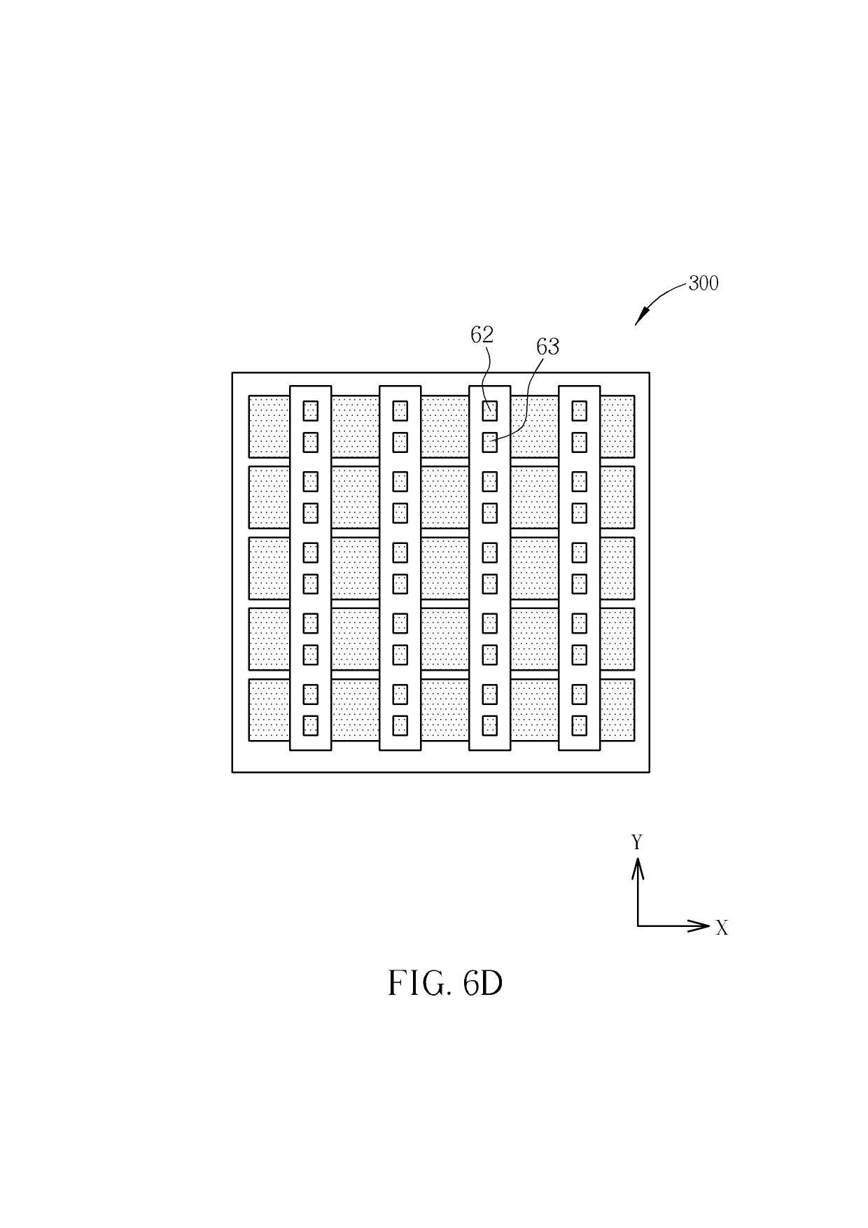

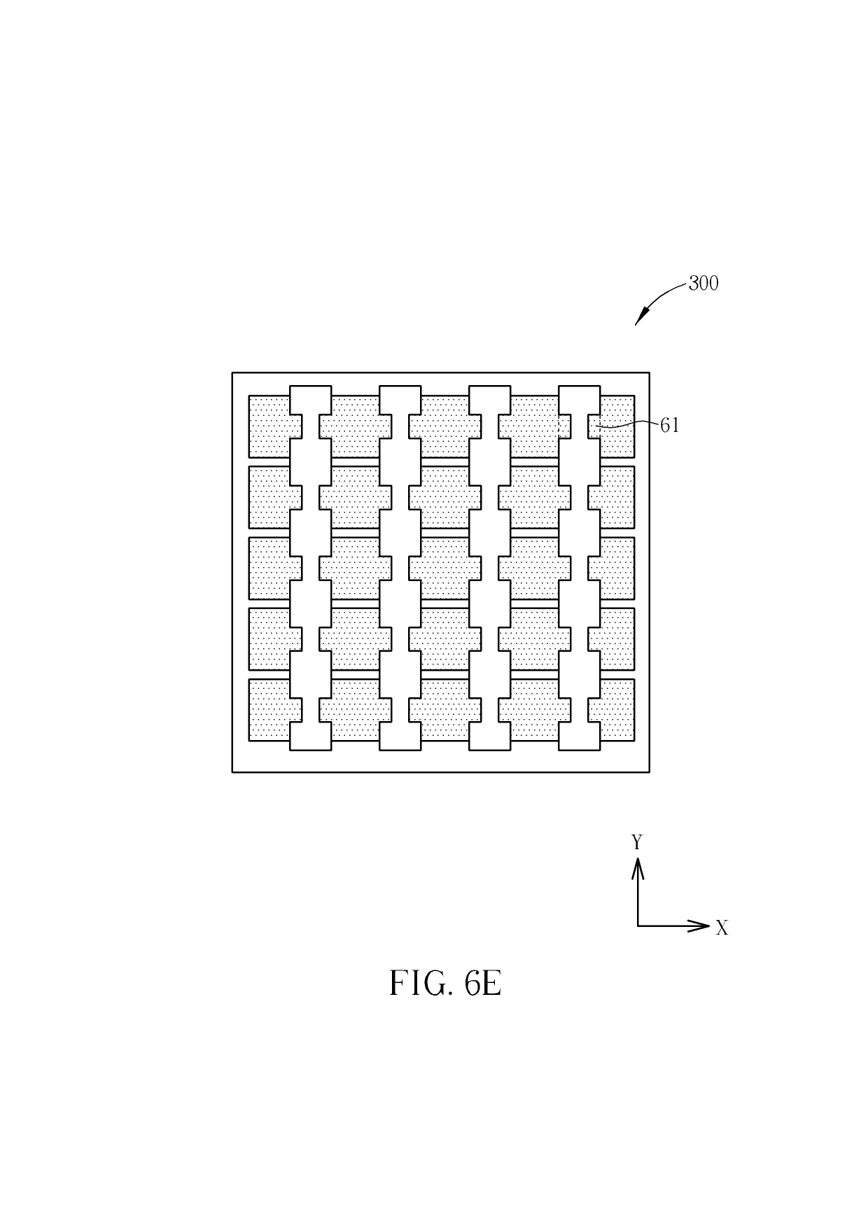

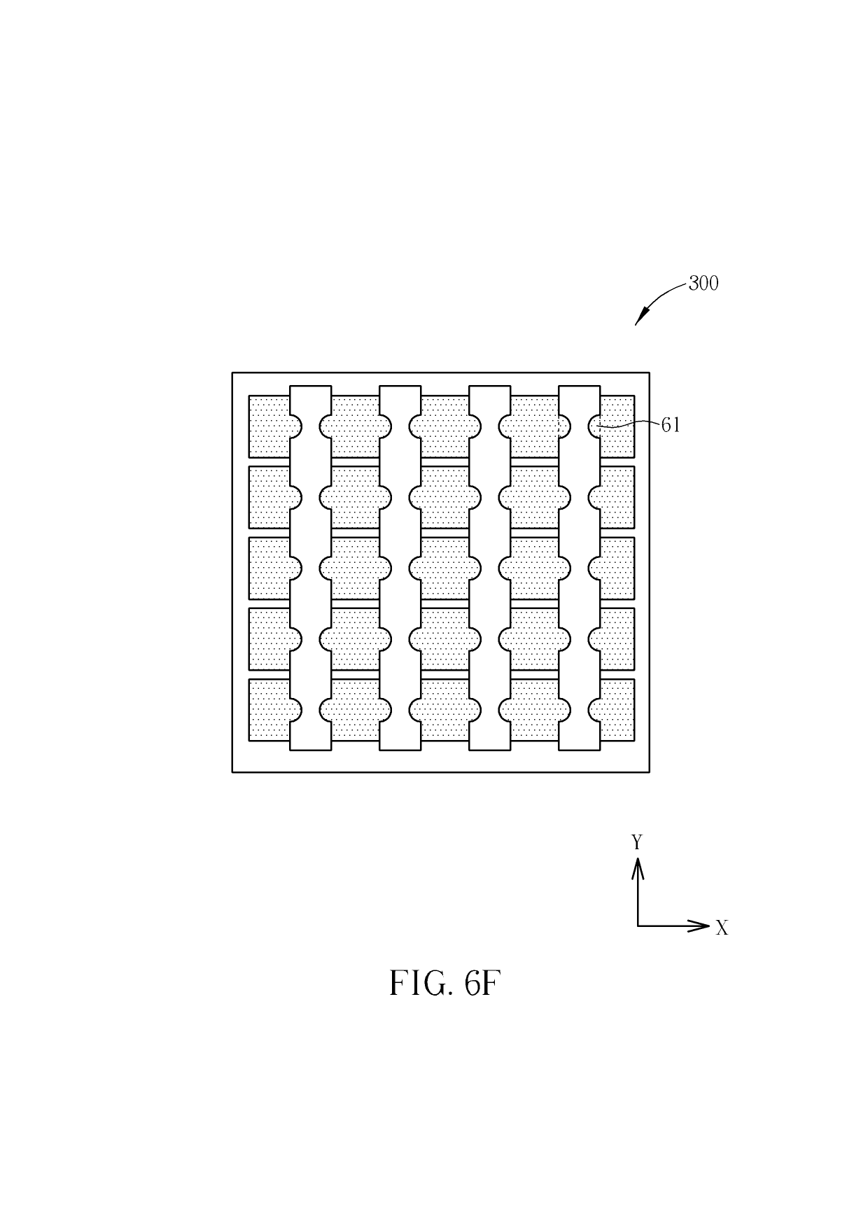

In addition, the hole 31 in FIG. 3 has a rectangular shape but not limited, the hole 31 may be any geometric figure, as long as the electric field lines induced on the receiving electrodes can be increased. Those skilled in the art may make modifications accordingly. For example, please refer to FIG. 6A to FIG. 6F that illustrate the holes having different geometric figures. In FIG. 6A, a hole 61 of the receiving electrodes is a circle. In FIG. 6B, the hole 61 has an irregular shape. FIG. 6C illustrates that each of the receiving electrodes has the single hole 62, that is, the hole 62 may lie in either the area of the receiving electrodes overlapping the driving electrodes or the area of the receiving electrodes not overlapping the driving electrodes. FIG. 6D illustrates the area of the receiving electrodes overlapping the driving electrodes includes holes 62 and 63. Moreover, FIG. 6E and FIG. 6F respectively illustrate the hole 61 having a rectangular shape and the hole 61 having a semicircular shape lying in side edges of the receiving electrodes. Therefore, a designer may properly change the geometric shape or an area of the hole to change the amount of the electric field lines induced on the receiving electrodes, which maybe regarded as a method of adjusting a sensing sensitivity of the capacitive touch display device 10 to increase a design flexibility of the capacitive touch display device.

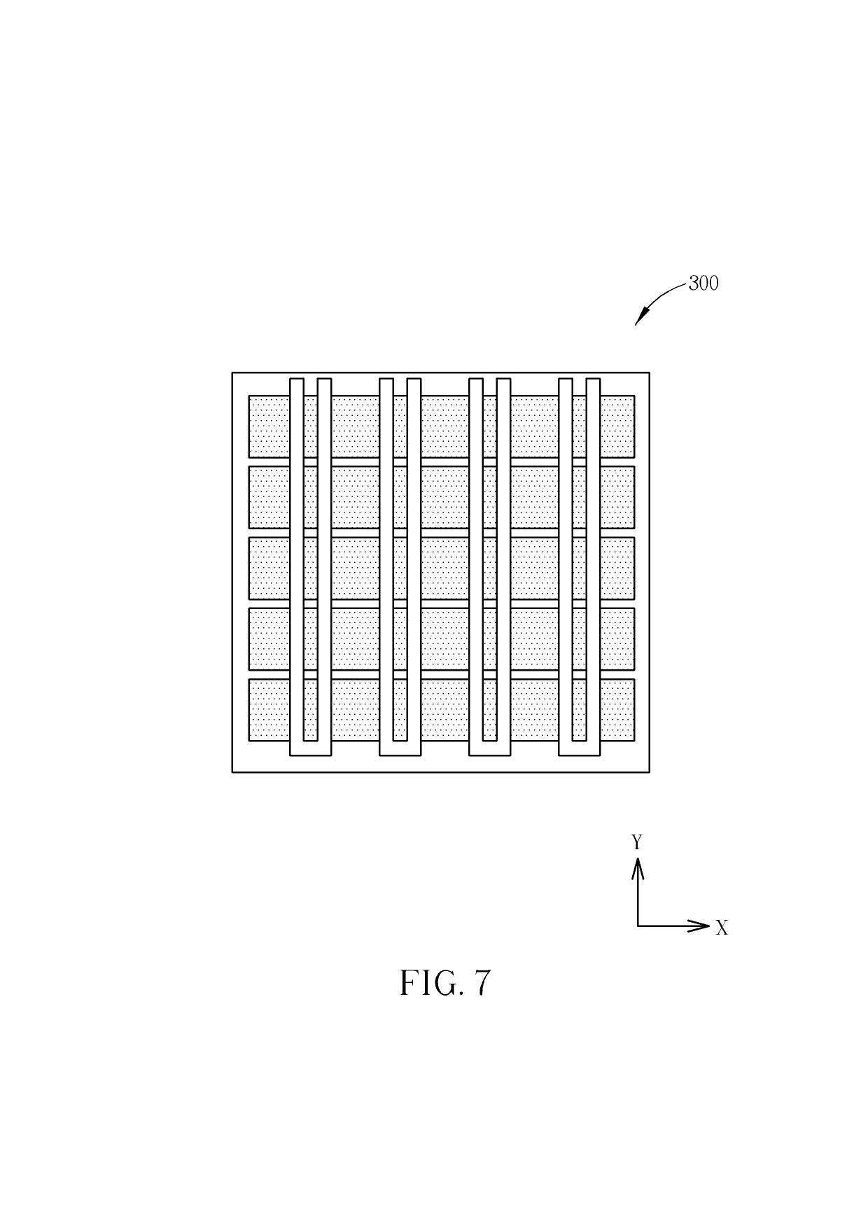

Preferably, projection areas of the receiving electrodes R1-RN overlapping the driving electrodes D1-DM shall be equal, such that the electric field lines induced on each of the receiving electrodes R1-RN are substantially equal and signal intensities of the receiving signal R_sig1-R_sigN are substantially equal to have the uniform sensing sensitivity of the capacitive touch display device. FIG. 7 illustrates the receiving electrodes having a U-shape. As shown in FIG. 7, in order to have the uniform sensing sensitivity, the projection areas of the receiving electrodes R1-RN overlapping the driving electrodes D1-DM are equal. Further more, the single U-shaped receiving electrode may be regarded as two receiving electrodes connected to each other, which increases the amount of the electric field lines as well.

To sum up, the present invention opens the hole in the receiving electrodes to increase the amount of the electric field lines induced on the receiving electrodes to increase the receiving signal difference value when the capacitive touch display device is touched by the human body. Therefore, the signal intensities of the receiving signals may be improved and the capacitive touch display device may easily determine the touch position. Further more, the present invention utilizes the sensing device having a double-layered structure to avoid the receiving electrodes completely exposed to the noise source, i .e. the display. As a result, the present invention may effectively enhance the receiving signal inducement and reduce the noise, such that the SNR of the capacitive touch display device may be greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A capacitive touch display device comprising:
a display;
a covering glass layer; and
a sensing device including:
a driving signal layer disposed on the display, the driving signal layer including a plurality of driving electrodes, for outputting a plurality of driving signals; and
a receiving signal layer disposed between the covering glass layer and the driving signal layer, the receiving signal layer including a plurality of receiving electrodes, for inducing the plurality of driving signals and outputting a plurality of touch sensing signals accordingly, wherein the plurality of receiving electrodes includes at least one hole for enhancing signal inducement.

2. The capacitive touch display device of claim 1, wherein part of the hole overlaps a projection area of one of the receiving electrodes overlapping one of the driving electrodes.

3. The capacitive touch display device of claim 2, wherein the hole completely overlaps the projection area of one of the receiving electrodes overlapping one of the driving electrodes.

4. The capacitive touch display device of claim 1, wherein the hole has a geometric shape.

5. The capacitive touch display device of claim 4, wherein the geometric shape is a rectangle, a circle or an irregular shape.

6. The capacitive touch display device of claim 1, wherein each of the receiving electrodes has a U-shape.

7. The capacitive touch display device of claim 1, wherein each of the plurality of driving electrodes respectively outputs a corresponding driving signal in order.

8. The capacitive touch display device of claim 1, wherein when one driving electrode of the plurality of driving electrodes outputs the corresponding driving signal, all other driving electrodes of the plurality of driving electrodes are coupled to a ground.

9. The capacitive touch display device of claim 1, wherein each of the plurality of receiving electrodes respectively induces the plurality of driving signals and outputs a corresponding touch sensing signal.

10. The capacitive touch display device of claim 1, further comprising:
a computing unit including a plurality of output terminals coupled to the plurality of driving electrodes, and a plurality of input terminals coupled to the plurality of receiving electrodes, for generating a touch detecting result to determine a touch position touched by a user according to the plurality of driving signal and a difference computing result generated by comparing the plurality of receiving signals before and after the capacitive touch display device is touched by a finger of the user.

11. The capacitive touch display device of claim 10, wherein if the difference computing result is less than a threshold value, the touch detecting result indicates a non-touched event.

12. The capacitive touch display device of claim 10, wherein if the difference computing result is greater than or equal to a threshold value, the touch detecting result indicates a touch event.

13. The capacitive touch display device of claim 12, wherein the computing unit determines a touch position touched by the user according to the difference computing result, positions of the plurality of driving electrodes and positions of the plurality of receiving electrodes.
